(19) United States
(12) Patent Application Publication
(10) Pub. No.: US 2026/0267127 A1
(43) Pub. Date: Sep. 10, 2026

(54) Method for Microscopy and Light-Field Microscope

(71) Applicant: Carl Zeiss Microscopy GmbH, Jena (DE)

(72) Inventors: Lars Loetgering, Jena (DE); Tiemo Anhut, Jena (DE); Thomas Egloff, Jena (DE); Markus Sticker, Jena (DE)

(21) Appl. No.: 19/555,038

(22) Filed: Mar. 3, 2026

(30) Foreign Application Priority Data
Mar. 5, 2025 (DE) 10 2025 108 329.0

(51) Int. Cl. G02B 21/36; G02B 3/00; G02B 21/02; G02B 21/08; G02B 21/14

(52) U.S. Cl. CPC G02B 21/367; G02B 3/0043; G02B 3/0056; G02B 21/02; G02B 21/086; G02B 21/14

(57) ABSTRACT

A set of partial images of a sample is recorded using a light-field microscope. A first number of partial images which form a first set of partial images and a second number of partial images which form a second set of partial images are selected from the recorded partial images, wherein the partial images of the first set are opposite the partial images of the second set in a sensor plane in relation to a reference point or a reference axis. A first intermediate result image is formed from the partial images of the first set, and a second intermediate result image is formed from the partial images of the second set. The first intermediate result image and the second intermediate result image are combined by calculation to form a result image which represents differences between the first intermediate result image and the second intermediate result image.

The current application claims the benefit of German Patent Application No. 10 2025 108 329.0, filed on 5 Mar. 2025, which is hereby incorporated by reference.

The invention relates in a first aspect to a method for microscopy according to the preamble of claim 1 and in a second aspect to a light-field microscope according to the preamble of claim 20.

A generic method and a generic light-field microscope are known for example from DE 10 2022 128 078.0 A1.

In a generic method, a set of partial images of a sample is recorded using a light-field microscope, wherein the light-field microscope comprises a two-dimensionally spatially resolving detector and a detection beam path having a microscope objective and a multi-lens array, the latter being arranged upstream of the detector in a plane optically conjugate to a back focal plane of the microscope objective or in the vicinity of such a plane.

A generic light-field microscope comprises at least the following constituent parts: a light source for providing illumination light, an illumination beam path for guiding the illumination light into a sample region, a two-dimensionally spatially resolving detector for detecting detection light coming from a sample in the sample region, a detection beam path with a microscope objective and a multi-lens array for guiding the detection light into a sensor plane of the detector, wherein the multi-lens array is arranged upstream of the detector in a plane optically conjugate to a back focal plane of the microscope objective or in the vicinity of such a plane, and a control unit for evaluating measurement data from the detector.

Fluorescence imaging of three-dimensional microscopic objects is of extraordinarily great value in many fields of biological and medical research and routine. Moreover, processes in organs, tissues and organisms are increasingly being examined in biomedical research. By way of example, the neuronal reaction to stimuli or the propagation of pulses in the muscle tissue, etc., is of interest here. In that case, the requirement is not for structural examinations at the highest resolution but rather for the fast acquisition of three-dimensional image data. Then, the temporal and/or spatial relative change of fluorescent signals is measured in these image data, i.e. ΔF/F₀. The actual image is only a source of data and, as a rule, serves for no further analysis. Since e.g. neuronal structures remain more or less stationary during the fast volume recording, the fast temporal information can be assigned to certain regions of the neuronal structures, if e.g. the structure is recorded at the start of the measurement or at any other time during the measurement.

In recent years, discussions on fast image acquisition increasingly consider light-field microscopy (LFM). The latter is advantageous in that a volume with an axial extent of several ten micrometres to several millimetres can be reconstructed from a single camera acquisition, the latter generally being implemented within fractions of seconds. Different embodiments are possible in relation to LFM. In what is known as spatial domain LFM, a micro-lens array (MLA) is arranged in the detection beam path in a plane conjugate to the object plane. In that case, a camera sensor located in the back focal plane (BFP) thereof is used for detection purposes.

However, Fourier LFM is the method more intuitive for microscopy. In Fourier LFM, the MLA is arranged in a plane that is conjugate to the pupil plane of the objective. Detection is once again implemented in the BFP of the MLA. In this case, real image representations of the sample volume are captured as partial images within the recorded camera image, said real image representations however in each case following different parallactic viewing directions onto the sample. On account of the parallax, an axial shift of an emitting fluorescence molecule in the object space causes a lateral shift of the signal on the camera sensor, which depends on the respective micro-lens under consideration.

Various algorithms are available for reconstructing the structural volume information from the raw data. A first algorithm initially separates all partial image data from the camera image to form an image stack, with each partial image of this stack corresponding to a viewing direction onto the sample. To calculate the image content of a certain axial sample plane, each partial image of this stack is now shifted by the parallactic shift expected for the chosen axial plane. A further method uses a joint deconvolution (jDCV) approach. This requires knowledge of each PSF for each microlens, and the processing duration is significantly increased. In return, this results in a significantly higher-contrast image.

Both of the aforementioned methods serve to create three-dimensional image information and supply the best possible structural image representation of the sample. Especially when observing the temporal dynamics of calcium transients, however, only the temporal dynamics at a specific location should be detected from the raw data with a high temporal resolution and good signal-to-noise ratio.

In addition to fluorescence-based imaging, which was only addressed briefly in the foregoing, methods based on differences in the optical density have become established, wherein the imaging makes use of the representation of phase differences.

Differential phase contrast (DPC) microscopy for scanning microscopes was described for the first time in [3]. In that context, a segmented detector was installed in a laser scanning microscope (LSM). Subtracting the signals measured on the individual segments of the detector from each other supplies a signal proportional to a phase gradient of the sample.

A generalization of this principle to wide-field systems is described in [1]. In particular, this document demonstrates that a segmented light source in a wide-field system can be used to generate DPC images. While [1] only describes a representation of the phase gradients, [2] discloses methods for deconvolving the transfer function such that the phase signal of the sample can be inferred from the phase gradient. While [1, 2] make use of light sources segmented on the illumination side, [4] made use of a half-pupil segmented on the detection side. This technique is referred to as “pupil-modulated differential phase contrast” (PMDPC), wherein a sequential acquisition is performed in [4]. In [4], the pupil was modulated using a spatial light modulator (SLM).

A problem addressed by the invention can be regarded as that of specifying a method and a light-field microscope in which additional microscopic information about a sample can be obtained quickly in comparison with the prior art.

This problem is solved by the method having the features of claim 1 and by the light-field microscope having the features of claim 20.

Advantageous variants of the method according to the invention and preferred exemplary embodiments of the light-field microscope according to the invention are explained below, in particular with reference to the dependent claims and the figures.

According to the invention, the method of the aforementioned type is developed by virtue of the following further method steps being performed:
a) a first number of partial images which form a first set of partial images and a second number of partial images which form a second set of partial images are selected from the recorded partial images, wherein the first number and the second number are both greater than or equal to 1 and wherein the partial images of the first set are opposite the partial images of the second set in a sensor plane of the detector in relation to a reference point or a reference axis, in particular in relation to an optical axis of the detection beam path,
b) a first intermediate result image is formed from the partial images of the first set, and a second intermediate result image is formed from the partial images of the second set, and
c) the first intermediate result image and the second intermediate result image are combined by calculation to form a result image which represents differences between the first intermediate result image and the second intermediate result image.

According to the invention, the light-field microscope of the aforementioned type is developed by virtue of the control unit being configured
A) to select, in particular following an interaction with a user, a first number of partial images which form a first set of partial images and a second number of partial images which form a second set of partial images from a set of multiple partial images recorded from the sample, wherein the first number and the second number are both greater than or equal to 1 and wherein the partial images of the first set are opposite the partial images of the second set in a sensor plane of the detector in relation to a reference point or a reference axis, in particular in relation to an optical axis of the detection beam path,
B) to form a first intermediate result image from the partial images of the first set and a second intermediate result image from the partial images of the second set, and
C) to combine the first intermediate result image and the second intermediate result image by calculation to form a result image which represents differences between the first intermediate result image and the second intermediate result image.

The light-field microscope according to the invention and the exemplary embodiments of the light-field microscope according to the invention as described herein and in particular the control units thereof may be configured to perform the method according to the invention or any of the variants of the method according to the invention described herein.

The method according to the invention and the variants of the method according to the invention described herein may be performed using the light-field microscope according to the invention or any of the exemplary embodiments of the light-field microscope according to the invention described herein.

A light-field microscope is used to obtain image information from a sample from different directions. For this purpose, a multi-lens array is present in a light-field microscope for dividing the detection beam path into a plurality of partial beam paths.

The term multi-lens array refers to an arrangement of a plurality of lenses in a plane, wherein the optical axes of the individual lenses are generally parallel to one another. However, this is not mandatory. In particular, the individual lenses may all have the same size and the same focal length, but this not mandatory either. The multi-lens array can also be referred to as a microlens array.

The multi-lens array may comprise a central region which is formed by a central lens or from three or four lenses. The optical axis can run through the central lens or symmetrically between the three or four lenses of the central region.

For example, the multi-lens array can comprise at least seven and up to 91 lenses. For example, the centres of the lenses of the multi-lens array can be located on a hexagonal grid or else on a square grid. For example, the lenses of the multi-lens array can all have the same size and/or all have the same focal length. However, some or all lenses of the multi-lens array may have different sizes and/or different focal lengths.

The illumination light is electromagnetic radiation, in particular in the visible spectral range and in adjoining ranges. The illumination light can also be referred to as excitation light; these two terms are used synonymously for the most part in this description.

The light source can be implemented by any light source capable of supplying the illumination light with a desired spectral composition and with a suitable intensity. For example, the light source might be a laser, a plurality of lasers, an LED, an LED module or a combination of these components. By preference, the illumination light can be coherent or at least partially coherent illumination light.

The term illumination beam path denotes all beam-guiding and beam-modifying components, e.g. lenses, mirrors, prisms, gratings, filters, stops, beam splitters, by means of which and via which the illumination light is guided from the light source to the sample to be examined.

The term sample space denotes the spatial region in which a sample to be examined can be arranged. In typical embodiments, a sample, e.g. by means of a sample holder or a sample frame, can be positioned or secured on an xy-stage which is adjustable in lateral directions with respect to an optical axis. A z-drive can be present to modify the distance between the sample stage and a microscope objective.

In principle, the sample can be any kind of sample. The light-field microscope according to the invention and the method according to the invention are suitable for examining biological samples in particular.

Detection light is light emitted by the sample to be examined, in particular as a consequence of said sample being irradiated by the illumination light. In order for the light to be able to be referred to as detection light, it is only necessary that the light is emitted by the illuminated sample or that in any case it comes from the illuminated sample. Typically, the detection light may be reflected, transmitted, diffracted and/or scattered illumination light.

The two-dimensionally spatially resolving detector may comprise one or more of the following elements or following components: CCD element, CMOS element, SPAD element.

The sensor plane of the detector is the plane in which the detection light is detected.

The term detection beam path in particular denotes beam-guiding and beam-modifying optical components, for example objectives, lenses, mirrors, prisms, gratings, filters, stops, beam splitters, modulators, for example spatial light modulators (SLM), by means of which and via which the detection light is guided from the sample to be examined to the detector. The microscope objective is part of the detection beam path.

The optical axis of the detection beam path is given by the optical axis of the microscope objective. Commercially available microscope objectives may be used, in principle.

The term pupil plane denotes a plane which is perpendicular, in particular with respect to the optical axis of the illumination beam path or of the detection beam path, and which is optically conjugate to a back focal plane of the respective microscope objective. The term intermediate image plane denotes a plane which is perpendicular, in particular with respect to the optical axis of the illumination beam path or of the detection beam path, and which is optically conjugate to an image plane of the respective microscope objective.

A partial image refers to an individual image generated by an individual lens of the multi-lens array in the sensor plane of the detector.

The totality of the images generated by lenses of the multi-lens array in the sensor plane of the detector is referred to as a set of partial images.

When the detector and the detection beam path are suitably dimensioned, the number of partial images in a set of partial images is the same as the number of lenses in the multi-lens array, i.e. an image is recorded by the detector for each lens in the multi-lens array.

In order to avoid overlap or crosstalk between individual partial images, a field stop that limits the size of the partial images in the sensor plane can advantageously be arranged in an intermediate image plane of the detection beam path.

The terms first and second sets of partial images each denote a subset of the totality of the partial images.

Selecting the partial images for the first and second sets of partial images is the method step in which the elements of the first and second sets are defined.

The first set may comprise exactly one first partial image, and the second set may comprise exactly one second partial image.

The selection can be made following an interaction with a user in particular. For example, a user may specify a partial image for the first set, and the control unit can then automatically select a second partial image for the second set, this second partial image being located opposite the first partial image of the first set in relation to the optical axis of the detection beam path. Alternatively, the selection may also be defined in software.

The feature whereby partial images are opposite one another in relation to the reference point or the reference axis, in particular in relation to the optical axis, may advantageously include such partial images having the same distance from the reference point or the reference axis in each case. The distance of a partial image from the reference point or from the reference axis, in particular the optical axis, may in each case be defined as the distance of a centre of the partial image in question from the reference point or from the reference axis, in particular from the optical axis.

The feature whereby partial images are opposite one another in relation to the reference point or the reference axis, in particular in relation to the optical axis, may advantageously furthermore include a connecting line between centres of partial images opposite one another in relation to the reference point or the reference axis, in particular in relation to the optical axis, running through the reference point or the reference axis, in particular through the optical axis, and being a straight line. For example, a connecting line between centres of partial images opposite one another in relation to the reference point or the reference axis, in particular in relation to the optical axis, may coincide with one of the lateral coordinate axes x, y or may be parallel to one of the lateral sides of the partial images.

Forming the first intermediate result image from the partial images of the first set may include linking the partial images of the first set to form the first intermediate result image using a computer operation.

Forming the second intermediate result image from the partial images of the second set may include linking the partial images of the second set to form the second intermediate result image using a computer operation.

Forming the result image from the first intermediate result image and the second intermediate result image may including linking the first intermediate result image and the second intermediate result image using a computer operation.

The first intermediate result image, the second intermediate result image and the result image each are images, i.e. data records, which contain an intensity as a function of two lateral coordinates. Typically, the direction of the optical axis of the detection beam path can be defined as the z-axis. The partial images, the first intermediate result image, the second intermediate result image and the result image then are data records which each contain an intensity as a function of the x-axis and the y-axis.

The term controller denotes all hardware and software components which interact with the components of the light-field microscope according to the invention for the intended function thereof. In particular, the control unit can comprise a computing device, for example a PC, and a camera controller. The computer resources of the control unit can be distributed among multiple computers and optionally a computer network, in particular also via the Internet. The controller can have in particular customary operating devices and peripherals, such as mouse, keyboard, screen, storage media, joystick, Internet connection. The controller can in particular read the image data from the detector and can also be configured and serve to control the light source.

One basic concept of the present invention can be regarded as that of using a set of partial images recorded by a light microscope to obtain microscopic information about a phase object or, in other words, the phase information of the sample by way of a skillful combination and evaluation of selected partial images.

A first essential advantage of the invention can be regarded as that of being able to obtain additional microscopic information by using a known measurement setup.

A further advantage of the invention can be regarded as that of providing a method and an arrangement which enable the detection of optical phase differences.

In this context, the simultaneous acquisition of multiple detection angles within and outside of a numerical illumination aperture, possible in the case of a light-field microscope, was found to be advantageous. In comparison with [4], for instance, this allows the measurement data required for the evaluation in each case to be acquired very quickly.

A further advantage of the invention can ultimately be seen as that of a phase image calculated for different detection angles allowing regions of interest to be found particularly quickly in transparent and optionally unstained samples.

While the modulation in [4] using a spatial light modulator constitutes a phase modulation of the light, the modulation of the light in the invention described herein can be regarded as an amplitude modulation.

In principle, there is freedom of design in view of selecting the first number of partial images and the second number of partial images. In a particularly preferred variant of the method according to the invention, the first number of partial images in the first set is equal to the second number of partial images in the second set.

In principle, a certain partial image is not precluded from being both an element of the first set and an element of the second set. However, the first set and the second set preferably do not contain any elements in common, i.e. the first set and the second set are preferably disjoint.

In principle, the first set comprising exactly one first partial image and the second set comprising exactly one second partial image is sufficient to implement the method according to the invention. Since it is known that the different partial images each correspond to different directions of view as regards the sample, microscopic information about a comparatively small solid angle range is obtained when only one partial image is selected for each of the first set and the second set. However, it is also possible for the first set and/or the second set to contain multiple images each. For example, this may be preferable if microscopic information should be obtained over a larger solid angle range.

By preference, each partial image of the first set may be directly adjacent to at least one further partial image of the first set in that case, and/or each partial image of the second set may be directly adjacent to at least one further partial image of the second set.

For example, the first set may contain all partial images in a first quadrant of the sensor plane, and/or the second set may contain all partial images in a second quadrant of the sensor plane. In another variant, the first set may contain all partial images in a first half of the sensor plane, and/or the second set may contain all partial images in a second half of the sensor plane.

If the multi-lens array is arranged such that the optical axis of one of the lenses in the multi-lens array coincides with the optical axis of the detection beam path, then the partial image corresponding to this lens is also located on the optical axis of the detection beam path and may therefore be referred to as the central partial image. Since there is no partial image opposite this partial image in relation to the optical axis, it is preferable in this case for neither the first set nor the second set to contain this central partial image.

In principle, performing the sequence of steps a), b) and c) a single time is sufficient to implement the invention. However, the sequence of steps a), b) and c) is preferably performed multiple times with in each case different combinations of partial images in the first set and/or the second set.

If the first set comprises exactly one first partial image and the second set comprises exactly one second partial image, then, for example, the sequence of steps a), b) and c) can particularly preferably be performed multiple times for different pairs of first partial image and second partial image, wherein the different pairs differ in each case in terms of the distance of the first partial image from the second partial image and/or in terms of the orientation of the connecting line between the centres of the first partial image and of the second partial image.

In principle, it is possible for the sample to be illuminated in reflected light. However, the sample is preferably illuminated in transmitted light.

In a preferred exemplary embodiment of the light-field microscope according to the invention, the illumination beam path for illuminating the sample in transmitted light comprises a condenser.

Advantageously, the condenser has a numerical aperture which is slightly greater than, similar to or equal to a numerical aperture of the microscope objective. This leads to the back focal plane of the microscope objective being fully illuminated and, should the multi-lens array be dimensioned accordingly, may lead to the multi-lens array also being fully illuminated. Advantageously, for those partial images for which the evaluation according to the invention is performed, the numerical aperture of the illumination, in particular the numerical aperture of the condenser, is equal to the numerical aperture of the microscope objective, and/or the numerical aperture of the illumination for these partial images corresponds to the region of the lenses in the multi-lens array that corresponds to the partial images.

However, it is also possible for the numerical aperture of the illumination and in particular of a condenser to be smaller than the numerical aperture of the microscope objective. This leads to the aperture of the microscope objective not being fully illuminated and, should the multi-lens array be dimensioned accordingly, may lead to the illumination no longer extending to all the lenses of the multi-lens array. In that case, images of the sample in dark-field illumination or partial bright and dark-field illumination are obtained for those lenses that are no longer illuminated or only partially illuminated. The evaluation of these images may also be expedient.

Forming the first intermediate result image may entail summing the partial images of the first set, said partial images having been multiplied by weighting factors in particular, and/or forming the second intermediate result image may entail summing the partial images of the second set, said partial images having been multiplied by weighting factors in particular. The weighting factors may serve to compensate for different brightnesses of the partial images that may be present for apparatus-related reasons. If such compensation is not necessary, the weighting factors may be 1 in each case.

In a preferred variant of the method according to the invention, the first intermediate result image is formed by summing the partial images of the first set, and/or the second intermediate result image is formed by summing the partial images of the second set.

Forming the result image may entail forming a difference between the first intermediate result image, the latter having been multiplied by a weighting factor in particular, and the second intermediate result image, the latter having been multiplied by a weighting factor in particular. The weighting factors may serve to compensate for different brightnesses of the first intermediate result image and of the second intermediate result image that may be present for apparatus-related reasons. If such compensation is not necessary, the weighting factors may be 1 in each case.

In a preferred variant of the method according to the invention, the result image is formed by forming the difference between the first intermediate result image and the second intermediate result image.

In a further preferred variant of the method according to the invention, the result image is formed by forming the difference between the first intermediate result image and the second intermediate result image and by dividing the difference by the sum of the partial images of the first set and the partial images of the second set.

In a further preferred variant of the method according to the invention, the result image is a phase gradient image of the sample, which represents the phase gradient in the direction of a connecting line between the opposing partial images.

In principle, filters, in particular switchable filters, for spectral conditioning of the illumination light and/or of the detection light could be present in the illumination beam path and/or in the detection beam path. However, deviating from fluorescence microscopy in particular, the absence of a wavelength shift between illumination light and detection light is essential for the present invention. Should a phase gradient image of the sample be obtained, it is preferable for no colour filters to be arranged in the detection beam path.

A phase contrast image of the sample is calculated from the result image in a preferred variant of the method according to the invention.

In a preferred variant of the method according to the invention, a phase contrast image of the sample is calculated by way of numerically integrating the result image.

In a variant, this numerical integration may include, for example, a deconvolution of a phase transfer function and/or an iterative deconvolution of a two- or three-dimensional phase contrast function and/or of a two- or three-dimensional absorption distribution. In addition to that or in an alternative, the numerical integration may include a Hilbert transform.

In a preferred variant of the method according to the invention, a phase contrast image φ of the sample is calculated by way of calculating:

$$ϕ ∝ iFT ( FT ( Δ I ) / h ) \qquad ( 1 )$$

where ΔI is a phase gradient image corresponding to the result image,
h is a transfer function,
FT represents a Fourier transform and
iFT represents an inverse Fourier transform.

In a first preferred variant, the transfer function h is given by the spatial frequency k in the direction in which the phase gradient image ΔI is formed.

In a second preferred variant, the transfer function h is given by h=exp(j*arctan(y/x)),
where j=\sqrt{−1} is the imaginary unit,
exp denotes the exponential function and
arctan denotes the inverse of the tangent.

In a further preferred variant, the phase contrast image φ of the sample is calculated using a Hilbert transform. More specifically, the phase contrast image φ of the sample is calculated approximately by way of calculating

$$ϕ ∝ imag [ iFT ( exp ( j * arctan ( y / x ) ) FT ( δ I ) ) ] \qquad ( 2 )$$

where j=\sqrt{−1} is the imaginary unit,
∂ₓI is a phase gradient of I in the x-direction,
∂_{y}I is a phase gradient of I in the y-direction,
δI=∂ₓI+j·∂_{y}I is a complex-valued intensity difference,
imag denotes the imaginary part and
iFT is an inverse Fourier transform.

By forming the complex-valued intensity difference δI, the horizontal intensity derivative ∂ₓI and the vertical intensity derivative ∂_{y}I are encoded in the real and imaginary parts of an array of complex numbers. Storage space and computing time can be saved because both the initial functions and the target functions of the Fourier transforms are complex valued in that case.

The resulting phase image φ is then approximated according to the Hilbert transform given in Equation (2).

In this case, the phase gradient ∂ₓI in the x-direction can be obtained by forming the difference between two partial images on the x-axis that are opposite one another in relation to the optical axis, and/or the phase gradient ∂_{y}I in the y-direction can be obtained by forming the difference between two partial images on the y-axis that are opposite one another in relation to the optical axis.

In a third preferred variant for the transfer function h, the transfer function h is given by the phase transfer function WOTF(k) explained in paragraphs [0070] to [0072] and Equations 5 to 8 in EP24184623A1. The accuracy of the numerical integration is improved by using this phase transfer function WOTF(k).

A central partial image or an integrated signal of the detector, said signal optionally being integrated over the partial images used or over all partial images, can be used to determine a proportion of illumination light absorbed by the sample in transmitted-light illumination.

The phase image obtained may serve as an overview image, in which regions of interest for a subsequent fluorescence acquisition are identified. In a particularly preferred configuration, the light-field microscope according to the invention is configured to overlay a fluorescence image of the sample on a phase contrast image of the sample and/or a phase contrast image of the sample.

Further advantages and features of the method according to the invention and of the light-field microscope according to the invention are explained below in association with the attached figures, in which:

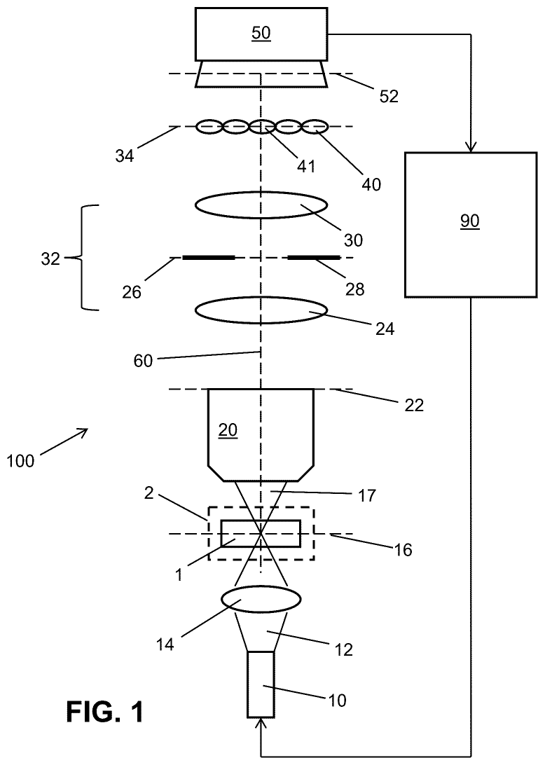

FIG. 1: shows an exemplary embodiment of the light-field microscope according to the invention;

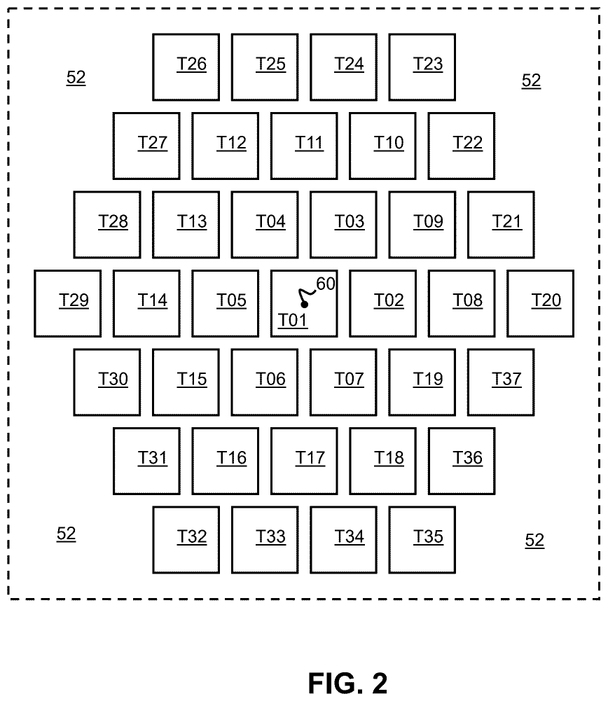

FIG. 2: shows a schematic illustration of the partial images in a sensor plane of the detector;

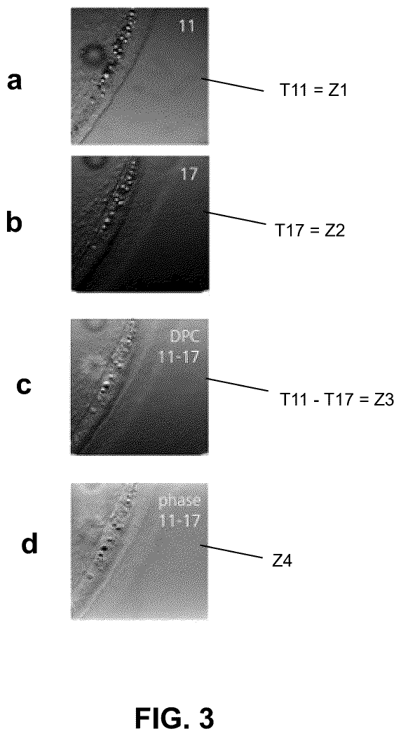

FIG. 3: shows an example of the generation of a result image; and

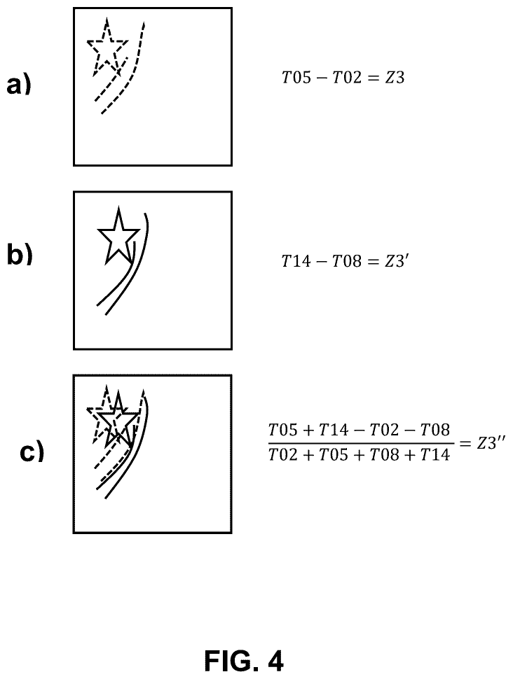

FIG. 4: shows an example for the display of result images.

Identical and identically acting components are generally provided with the same reference signs in the figures.

An exemplary embodiment of a light-field microscope 100 according to the invention will be explained with reference to FIGS. 1 and 2.

FIG. 1 schematically shows the light-field microscope 100 according to the invention. FIG. 2 schematically shows the arrangement of partial images T01 to T37 in a sensor plane 52 of a detector 50 of the light-field microscope 100.

According to the invention, the light-field microscope 100 initially comprises a light source 10, for example an LED, for providing illumination light 12 and an illumination beam path for guiding the illumination light 12 into a sample region 2. In the exemplary embodiment shown, the illumination beam path comprises a condenser 14, which is illustrated schematically. For example, the sample region may be realized by an xyz-displacement stage, on which a sample container or sample carrier transparent to the illumination light 12 is situated, with the sample 1 being arranged on or in said sample container or sample carrier. A region of the sample 1 to be examined can be changed with the aid of the xyz-displacement stage. In particular, it is possible to modify the position of a focal plane 16 of the microscope objective 20 within the sample 1.

According to the invention, the light-field microscope 100 furthermore comprises the two-dimensionally spatially resolving detector 50 for detecting detection light 17 coming from a sample 1 in the sample region 2 and a detection beam path for guiding the detection light 17 into a sensor plane 52 of the detector 50. For example, the detector 50 can be realized by a CCD camera, a CMOS camera or a SPAD camera. According to the invention, the detection beam path comprises a microscope objective 20 and a multi-lens array 40, the latter being arranged upstream of the detector 50 in a plane 34 optically conjugate to the back focal plane 22 of the microscope objective 20, i.e. in a pupil plane, in the exemplary embodiment shown. In the exemplary embodiment depicted in FIG. 1, the detection beam path furthermore comprises a tube lens 24, which realizes a first lens of a relay optics unit 32, and a further lens 30, which realizes a second lens of the relay optics unit 32. The relay optics unit 32 forms an intermediate image plane 26 in which a field stop 28 serving to avoid an overlap of partial images in the sensor plane 52 of the detector 50 is arranged in the depicted exemplary embodiment. The sensor plane 52 of the detector is situated in an intermediate image plane, and consequently in a plane optically conjugate to the focal plane 16 of the microscope objective 20 and to the intermediate image plane 26. An optical axis 60 of the detection beam path runs perpendicular to the lateral directions of extent of the multi-lens array 40 and to the sensor plane 52 of the detector 50. The optical axis 60 corresponds to the optical axis of the microscope objective 20.

The light-field microscope 100 from FIG. 1 in essence serves to obtain phase gradient images and phase contrast images of the sample 1. Colour filters for spectrally conditioning of the illumination light and/or of the detection light may be present in the illumination beam path and/or in the detection beam path. However, since—in contrast to fluorescence microscopy in particular—the absence of a wavelength shift between the illumination light and the detection light is essential for the present invention, colour filters possibly present are designed such that they transmit the non-wavelength shifted detection light. Moreover, they may be switchable in such a way that they can be removed from the respective beam path. In order to ensure that the pupil in the back focal plane 22 of the microscope objective 20 is fully illuminated and in order thus to ensure that a maximum illumination of the multi-lens array 40 is achieved, the condenser 14 preferably has a numerical aperture which is greater than or equal to a numerical aperture of the microscope objective 20. Should this not be the case, i.e. should the aperture of the condenser be smaller than the numerical aperture of the microscope objective 20, some of the lenses of the multi-lens array 40 might optionally not be used for transmitted-light imaging.

FIG. 2 shows an exemplary illustration of partial images T01 to T37, which are generated by a multi-lens array 40 with 37 singlet lenses, in the sensor plane 52 of the detector 50. In the example shown, these 37 lenses should each have the same diameter and the same focal length. The distance at which the multi-lens array 40 is arranged relative to the sensor plane 52 is equal to this focal length of the lenses. A lens 41 of the multi-lens array 40 is situated on the optical axis 60 of the detection beam path, the optical axis of said lens coinciding with the optical axis 60 of the detection beam path and said lens being able to be referred to as the central lens 41. The partial image T01 in the sensor plane 52 is generated by this central lens 41.

The arrangement of a light-field microscope, which is illustrated in FIG. 1 and in which the multi-lens array 40 is arranged in a plane optically conjugate to the back focal plane 22 of the microscope objective 20, is also referred to as a Fourier light-field microscope. This arrangement of the multi-lens array 40 allows the assignment of the partial images T01 to T37 measured by the detector 50, which are also referred to as facets, to emission angles which—as known—allow a plenoptic combination by calculation in the case of fluorescence imaging. In the case of transmitted-light bright-field microscopy, the lenses in the multi-lens array 40 allow an angle-selective detection of the transmitted detection light 17.

Finally, according to the invention, the light-field microscope 100 from FIG. 1 contains a control unit 90 which serves for evaluating measurement data of the detector 50 and which may be realized by a PC, for example. According to the invention the control unit 90 is configured
A) to select a first number of partial images which form a first set of partial images and a second number of partial images which form a second set of partial images from a set of multiple partial images T01, . . . , T37 (see FIG. 2) recorded from the sample 1, wherein the first number and the second number are both greater than or equal to 1 and wherein the partial images of the first set are opposite the partial images of the second set in a sensor plane 52 of the detector 50 in relation to an optical axis 60 of the detection beam path,
B) to form a first intermediate result image from the partial images of the first set and a second intermediate result image from the partial images of the second set, and
C) to combine the first intermediate result image and the second intermediate result image by calculation to form a result image which represents differences between the first intermediate result image and the second intermediate result image.

The light-field microscope 100 and, in particular, the control unit 90 may be configured to perform the method according to the invention or all or some of the variants of the method according to the invention described herein.

Examples thereof will be described below with reference to FIGS. 2 to 4.

In FIG. 2, let the x-axis run in the horizontal direction and the y-axis in the vertical direction. The z-axis should coincide with the optical axis 60.

According to the invention, partial images opposite one another in relation to the optical axis 60 may be processed, and combined by calculation in particular, in order to initially form intermediate result images, then form result images, in particular phase gradient images, and ultimately form phase contrast images.

An example in this respect will be explained with reference to FIGS. 2 and 3. In this case, the partial image T11 constitutes the first set of partial images, and the partial image T17 constitutes the second set of partial images. As evident from FIG. 2, the partial images T11 and T17 lie opposite one another in relation to the optical axis 60 and the central partial image T01.

In the example shown, the centres of the partial images T11 and T17 each have the same distance from the optical axis 60, and a connecting line between these centres intersects the optical axis 60 and forms a straight line.

Forming the first intermediate result image Z1 and the second intermediate result image Z2 is simple in this case. The first intermediate result image Z1 is identical to the partial image T11 (FIG. 3a), and the second intermediate result image Z2 is identical to the partial image T17 (FIG. 3b).

As evident from FIG. 3, the partial images T11 and T17 each show structures which, although they have similarities, are not identical owing to the different viewing angles on the sample 1.

In the example illustrated in FIG. 3, the result image Z3 is subsequently obtained by Z3=T11−T17 (FIG. 3c) and consequently obtained by forming the difference between the partial images T11 and T17.

It can be shown that the difference image Z3 is proportional to the phase gradient of the sample 1. More precisely, the difference image is proportional to the component of the phase gradient in the direction of the connecting line of the centres of those partial images T11 and T17 from which the difference was formed. In the example shown, Z3 thus is the y-component of the phase gradient of the sample 1.

Using the integration methods described in the general part of the description, it is subsequently possible to convert the phase gradient image Z3 into the phase image illustrated in FIG. 3d.

For example, a phase contrast image φ of the sample 1 can be calculated by calculation of

$$ϕ ∝ iFT ( FT ( Δ I ) / {k}_{y} ) .$$

This calculation represents a numerical integration of the measured DPC intensity difference image. Here, ΔI is the phase gradient image which corresponds to the result image Z3. Optionally, it is also possible to normalize the difference T11−T17 by division by T11+T17, i.e. ΔI can be described by

$$Δ I = ( T 11 - T 17 ) / ( T 11 + T 17 )$$

It may be assumed that ΔI is proportional to the phase gradient, i.e.

$$Δ I ∝ \frac{\partial ϕ}{\partial y}$$

Here, k_{y} is the transfer function h, which in this example corresponds to the spatial frequency k in the y-direction, i.e. in the direction along which the phase gradient image ΔI is formed. Moreover, FT represents a Fourier transform, and iFT represents an inverse Fourier transform.

A corresponding calculation can be performed for the horizontal phase gradient, i.e. the phase gradient in the x-direction. To this end, use could be made of e.g. the difference between the partial images T05 and T02, the difference between the partial images T14 and T08 or the difference between the partial images T29 and T20 and the transfer function h=kₓ.

Instead of the transfer functions h=k_{y} or h=kₓ, the further examples of the transfer function h explained in the general part of the description could also be used for h.

A significant advantage of the invention is that, in contrast to the prior art, where sequentially recorded half-pupils or half-pupil-limited images are used in the illumination or detection, phase gradient images of different directions and phase images for in each case different spatial frequency intervals can also be generated from a single acquisition of a sample, depending on which partial images are evaluated.

It is thus essential for the invention that the pupil is decomposed by the multi-lens array into a large number of small partial pupils, whereby it is possible to selectively subtract specific selected directions.

For example, instead of the difference between the partial images T11 and T17 illustrated in FIG. 3, the difference between the images T05 and T02 or the difference between the images T14 and T08 could also be evaluated. From considering the arrangement of the partial images in FIG. 2, it is clear that there are numerous further options for data evaluation and determination of phase gradient images.

The figures do not show that the observed sample structures in the phase gradient images and in the phase images or DCP images calculated therefrom are ever finer, the farther the evaluated opposing partial images are spaced apart from one another. The reason for this can be found in the fact that the spatial frequencies captured by the relevant lenses in the multi-lens array 40 are ever greater, the farther the relevant lenses are spaced apart from the optical axis 60.

The division of the pupil into a large number of partial pupils by the multi-lens array 40 moreover offers the possibility of a multi-modal representation of phase gradients. This is explained on the basis of FIG. 4.

FIG. 4a) shows a phase gradient image Z3 formed from the partial images T05 and T02, and FIG. 4b) shows a phase gradient image Z3′ formed from the partial images T14 and T08. Since the partial images T14 and T08 are farther away from the optical axis 60 than the partial images T05 and T02, the structures in the phase gradient image Z3′ correspond to higher solid angle frequencies than those in the phase gradient image Z3.

FIG. 4c) then shows an overlay Z3″ of Z3 and Z3′, with the structures in Z3 and Z3′ being represented using different line types in each case. In the example shown, the overlaid image was also normalized by way of dividing by the sum of the partial images T02, T05, T08, T14. Instead of the different line types, the overlay can be displayed on a screen using different colours for Z3 and Z3′. The relevant information is then readily available to a user in a single image. Phase gradient images of different spatial frequencies can thus be displayed in a differentiated manner, in terms of colour or otherwise graphically differentiated. It would also be possible to obtain phase gradient images for different spatial directions, for instance by forming the differences T02-T05 and T11-T17, and these phase gradient images in turn can be displayed in one image using different colours or in otherwise graphically differentiated fashion.

In contrast to the prior art, which describes differential phase contrast (DPC) systems in which illumination or detection is sequentially angle-selective such that a phase image of the sample can be calculated by deconvolution (DCV), the solution described here allows simultaneous capture of all partial images or facets such that different DPC images can be obtained from the data of a single acquisition.

### LIST OF REFERENCE SIGNS

1 Sample
2 Sample region
12 Illumination light
14 Condenser
16 Sample plane, object plane, focal plane of the microscope objective 20
17 Light coming from the sample 1
20 Microscope objective
22 Back focal plane of the microscope objective 20, pupil plane
24 Tube lens, first lens of the relay optics unit 32
26 Intermediate image plane
28 Field stop
30 Lens, second lens of the relay optics unit 32
32 Relay optics unit
34 Plane optically conjugate to the back focal plane 22 of the microscope objective 20, pupil plane
40 Multi-lens array
41 Central lens of the multi-lens array 40
50 Two-dimensionally spatially resolving detector, camera
52 Sensor plane of the camera, optically conjugate to the plane 16 in the sample 1 and to the plane 26
60 Optical axis of the detection beam path
90 Control unit
100 Apparatus according to the invention
arctan Inverse of the tangent
exp Exponential function
FT Fourier transform
h Transfer function
iFT Inverse Fourier transform
imag Imaginary part
j=\sqrt{−1} Imaginary unit
k Spatial frequency in the direction along which the phase gradient image ΔI is formed
T01 to T37 Partial images
WOTF(k) Phase transfer function
x, y, Z Coordinate axes
Z1 First intermediate result image
Z2 Second intermediate result image
Z3 Result image
Z3′ Result image
Z3″ Result image
Z4 Phase contrast image
∂ₓI x-component of the phase gradient of I
∂_{y}I y-component of the phase gradient of I
δI=∂ₓI+j·∂_{y}I Complex-valued intensity difference
φ Phase contrast image
ΔI Phase gradient image, result image

### REFERENCES

[1] Mehta, Shalin B., and Colin JR Sheppard. “Quantitative phase-gradient imaging at high resolution with asymmetric illumination-based differential phase contrast.” Optics letters 34.13 (2009): 1924-1926.
[2] Tian, Lei, and Laura Waller. “3D intensity and phase imaging from light field measurements in an LED array microscope.” Optica 2.2 (2015): 104-111.
[3] D. K. Hamilton and C. J. R. Sheppard, J. Microsc. 133, 27 (1984).
[4] Lu, H., Chung, J., Ou, X., & Yang, C. (2016). Quantitative phase imaging and complex field reconstruction by pupil modulation differential phase contrast. Optics Express, 24 (22), 25345-25361.

1. Method for microscopy, comprising:
recording a set of partial images of a sample using a light-field microscope, wherein the light-field microscope comprises a two-dimensionally spatially resolving detector and a detection beam path having a microscope objective and a multi-lens array, the latter being arranged upstream of the detector in a plane optically conjugate to a back focal plane of the microscope objective or in the vicinity of such a plane,
a) selecting a first number of partial images which form a first set of partial images and a second number of partial images which form a second set of partial images from the recorded partial images, wherein the first number and the second number are both greater than or equal to 1 and wherein the partial images of the first set are opposite the partial images of the second set in a sensor plane of the detector in relation to a reference point or a reference axis,
b) forming a first intermediate result image from the partial images of the first set, and forming a second intermediate result image from the partial images of the second set, and
c) combining the first intermediate result image and the second intermediate result image by calculation to form a result image which represents differences between the first intermediate result image and the second intermediate result image.

2. Method according to claim 1,
wherein
the first number of partial images in the first set is the same as the second number of partial images in the second set.

3. Method according to claim 1,
wherein
each partial image of the first set is directly adjacent to at least one further partial image of the first set and/or
each partial image of the second set is directly adjacent to at least one further partial image of the second set.

4. Method according to claim 1,
wherein
partial images opposite one another in relation to the reference point or the reference axis each have the same distance from the reference point or the reference axis.

5. Method according to claim 1,
wherein
a connecting line between centres of partial images opposite one another in relation to the reference point or the reference axis runs through the reference point or the reference axis and is a straight line.

6. Method according to claim 1,
wherein
the sequence of steps a), b) and c) is performed multiple times, wherein the respective combinations of partial images differ in the first set and/or the second set.

7. Method according to claim 1,
wherein
the first set comprises exactly one first partial image and the second set comprises exactly one second partial image and
the sequence of steps a), b) and c) is performed multiple times for different pairs of first partial image and second partial image,
wherein the different pairs differ in each case in terms of the distance of the first partial image from the second partial image and/or in terms of the orientation of the connecting line between the centres of the first partial image and of the second partial image.

8. Method according to claim 1,
wherein
the sample is illuminated in transmitted light.

9. Method according to claim 1,
wherein
the first intermediate result image is formed by forming the sum of the partial images of the first set and/or
the second intermediate result image is formed by forming the sum of the partial images of the second set.

10. Method according to claim 1,
wherein
the result image is formed by forming the difference between the first intermediate result image and the second intermediate result image, or
the result image is formed by forming the difference between the first intermediate result image and the second intermediate result image and by dividing the difference by the sum of the partial images of the first set and the partial images of the second set.

11. (canceled)

12. Method according to claim 1,
wherein
the result image is a phase gradient image of the sample which represents the phase gradient in the direction of a connecting line between two opposing partial images.

13. Method according to claim 1,
wherein
a phase contrast image of the sample is calculated by way of numerically integrating the result image.

14. Method according to claim 13,
wherein
the phase contrast image φ of the sample is calculated by calculation of
$$ϕ ∝ iFT ( FT ( Δ I ) / h ) ,$$
where ΔI is a phase gradient image corresponding to the result image,
h is a transfer function,
FT represents a Fourier transform and
iFT represents an inverse Fourier transform.

15. Method according to claim 13,
wherein
a transfer function h is given by the spatial frequency k in the direction in which the phase gradient image ΔI is formed.

16. Method according to claim 13,
wherein
a transfer function h is given by h=exp(j*arctan (y/x)), where
j=\sqrt{−1} is the imaginary unit,
exp denotes the exponential function and
arctan denotes the inverse of the tangent.

17. Method according to claim 13,
wherein
a phase contrast image φ of the sample is calculated approximately by calculation of
$$ϕ ∝ imag [ iFT ( exp ( j * arctan ( y / x ) ) FT ( δ I ) ) ] ,$$
where j=\sqrt{−1} is the imaginary unit,
∂ₓI is a phase gradient of I in the x-direction,
∂_{y}I is a phase gradient of I in the y-direction,
δI=∂ₓI+j·∂_{y}I is a complex-valued intensity difference,
imag denotes the imaginary part and
iFT represents an inverse Fourier transform.

18. Method according to claim 17,
wherein
the phase gradient ∂ₓI in the x-direction is obtained by forming the difference between two partial images which are located on the x-axis and are opposite one another in relation to the optical axis and/or
the phase gradient ∂_{y}I in the y-direction is obtained by forming the difference between two partial images which are located on the y-axis and are opposite one another in relation to the optical axis.

19. (canceled)

20. Light-field microscope, comprising:
a light source for providing illumination light,
an illumination beam path for guiding the illumination light into a sample region,
a two-dimensionally spatially resolving detector for detecting detection light coming from a sample in the sample region,
a detection beam path with a microscope objective and a multi-lens array for guiding the detection light into a sensor plane of the detector, wherein the multi-lens array is arranged upstream of the detector in a plane optically conjugate to a back focal plane of the microscope objective or in the vicinity of such a plane, and
a control unit for evaluating measurement data from the detector,
wherein
the control device is configured
A) to select a first number of partial images which form a first set of partial images and a second number of partial images which form a second set of partial images from a set of multiple partial images recorded from the sample, wherein the first number and the second number are both greater than or equal to 1 and wherein the partial images of the first set are opposite the partial images of the second set in a sensor plane of the detector in relation to a reference point or a reference axis,
B) to form a first intermediate result image from the partial images of the first set and a second intermediate result image from the partial images of the second set, and
C) to combine the first intermediate result image and the second intermediate result image by calculation to form a result image which represents differences between the first intermediate result image and the second intermediate result image.

21. Light-field microscope according to claim 20,
wherein
no colour filters are arranged in the detection beam path.

22. Light-field microscope according to claim 20,
wherein
the illumination beam path for illuminating the sample in transmitted light comprises a condenser, and
the condenser has a numerical aperture which is slightly greater than, similar to or equal to a numerical aperture of the microscope objective.

23. (canceled)

24. Light-field microscope according to claim 20,
wherein
in that the multi-lens array comprises a central region formed by a central lens or by three or four lenses, wherein the optical axis runs through the central lens or symmetrically between the three or four lenses of the central region.

25. Light-field microscope according to claim 20,
wherein
the multi-lens array comprises at least seven and up to 91 lenses.

26. Light-field microscope according to claim 20,
wherein
the centres of the lenses of the multi-lens array are located on a hexagonal grid or on a square grid.

27. Light-field microscope according to claim 20,
wherein
the lenses of the multi-lens array all have the same size and/or all have the same focal length.

28. Light-field microscope according to claim 20,
wherein
some lenses of the multi-lens array have a different size and/or a different focal length.

29. Light-field microscope according to claim 20,
configured to overlay a fluorescence image of the sample on a phase contrast image of the sample and/or a phase contrast image of the sample.
